(19) United States
(12) Patent Application Publication
(10) Pub. No.: US 2014/0185671 A1
(43) Pub. Date: Jul. 3, 2014

(54) VIDEO ENCODING AND DECODING METHOD AND APPARATUS USING THE SAME

(71) Applicants: Ha Hyun LEE, Seoul (KR); Jin Ho LEE, Daejeon-si (KR); Jung Won KANG, Daejeon-si (KR); Jin Soo CHOI, Daejeon-si (KR); Jin Woong KIM, Daejeon-si (KR)

(72) Inventors: Ha Hyun LEE, Seoul (KR); Jin Ho LEE, Daejeon-si (KR); Jung Won KANG, Daejeon-si (KR); Jin Soo CHOI, Daejeon-si (KR); Jin Woong KIM, Daejeon-si (KR)

(73) Assignee: ELECTRONICS AND TELECOMMUNICATIONS RESEARCH INSTITUTE, Daejeon-si (KR)

(21) Appl. No.: 14/136,709

(22) Filed: Dec. 20, 2013

(30) Foreign Application Priority Data
Dec. 27, 2012 (KR) 10-2012-0155309
Nov. 22, 2013 (KR) 10-2013-0142737

(51) Int. Cl. H04N 19/50; H04N 19/176; H04N 19/105; H04N 19/137

(52) U.S. Cl. CPC H04N 19/00569; H04N 19/00145; H04N 19/00278; H04N 19/00024
USPC 375/240.12

(57) ABSTRACT

Disclosed is a video decoding method supporting a plurality of layers including: decoding a first layer which is referred by a target block of a second layer to be decoded; determining a size of the target block of the second layer which uses information on the first layer; and performing prediction for the target block by using the information on the first layer according to a determined result.

This application claims the benefit of priority of Korean Patent Applications No. 10-2012-0155309 filed on Dec. 27, 2012 and No. 10-2013-0142737 filed on Nov. 22, 2013, which are incorporated by reference in their entirety herein.

### BACKGROUND OF THE INVENTION

1. Field of the Invention

The present invention relates to video encoding and decoding processes, and more particularly, to video encoding and decoding method and apparatus supporting a plurality of layers in a bit stream.

2. Discussion of the Related Art

Recently, as a broadcasting service having high definition (HD) resolution has been nationally and globally expanded, many users have been accustomed to high-resolution and high-definition videos, and as a result, many authorities spur the development of next-generation video devices. Further, as the interest for an HDTV and ultra high definition (UHD) having four times or more resolution is increased, a compression technique for higher-resolution and higher-definition videos has been required.

For video compression, an inter-prediction technique for predicting a pixel value included in a current picture from a previous and/or subsequent picture, an intra-prediction technique for predicting a pixel value included in a current picture by using pixel information in the current picture, an entropy coding technique for allocating a short code to a symbol having a high frequency and allocating a long code to a symbol having a low frequency, and the like may be used.

In the video compression technique, a technique of providing a constant network bandwidth under a limited operational environment of hardware without considering a flexible network environment is included. However, in order to compress video data applied to a network environment in which the bandwidth are frequently changed, a new compression technique is required, and to this end, a scalable video encoding/decoding method may be used.

### SUMMARY OF THE INVENTION

The present invention performs inter-layer texture prediction, only when sizes of encoding and decoding target blocks of a second layer are included in a specific range.

An object of the present invention is to reduce an increase of complexity according to various block sizes and when the inter-layer texture prediction indicator is entropy-encoded and decoded, occurrence probability becomes regular.

Another object of the present invention is to improve encoding and decoding efficiency of the video.

In accordance with an embodiment of the present invention, a video decoding method supporting a plurality of layers includes: decoding a first layer which is referred by a target block of a second layer to be decoded; determining a size of the target block of the second layer which uses information on the first layer; and performing prediction for the target block by using the information on the first layer according to a determined result.

In the determining of the size of the target block, all allowable block sizes defined in an encoding apparatus may be determined as the size of the target block.

In the determining of the size of the target block, a block size set by a predetermined rule implicitly defined with the encoding apparatus may be determined as the size of the target block.

In the determining of the size of the target block, a maximum block size allowed in the encoding apparatus may be determined as the size of the target block.

In the determining of the size of the target block, a minimum block size allowed in the encoding apparatus may be determined as the size of the target block.

The determining of the size of the target block may include parsing a size range indicator transmitted from the encoding apparatus, in which the size range indicator may include any one of a maximum size range syntax element and a minimum size range syntax element transmitted and included in any one of SPS, PPS, and a slice header.

The determining of the size of the target block may include parsing a maximum size range syntax element of the target block expressed by a difference value between the indicator for the minimum block size allowed in the encoding apparatus transmitted from the encoding apparatus and the minimum block size, in which the maximum block size of the target block may be determined by a sum of the minimum block size by the indicator and the difference value.

In the determining of the size of the target block, a syntax element expressed by the difference value between the minimum block size and the maximum block size allowed in the encoding apparatus transmitted from the encoding apparatus may be parsed.

The performing of the prediction for the target block may include parsing flag information indicating using the first layer, when intraBL prediction is applied to the target block; and using a decoded block signal of the first layer as a prediction signal with a differential signal, when the flag information is 1.

The performing of the prediction for the target block may include parsing flag information indicating using the first layer, when intraBL_skip prediction is applied to the target block; and using a decoded block signal of the first layer as a prediction signal without a differential signal, when the flag information is 1.

In accordance with another embodiment of the present invention, a video decoding apparatus supporting a plurality of layers includes a first layer decoding module configured to decode a first layer which is referred by a target block of a second layer to be decoded; and a second layer decoding module configured to determine a size of the target block of the second layer which uses the information of the first layer and perform prediction for the target block by using the information of the first layer according to the determined result.

According to the embodiments of the present invention, it is possible to provide video encoding/decoding method and apparatus capable of performing inter-layer texture prediction, only when sizes of encoding and decoding target blocks of a second layer are included in a specific range.

Further, an increase in complexity according to various block sizes may be reduced, and when an inter-layer texture prediction indicator is entropy-encoded and decoded, occurrence probability becomes regular.

As a result, video encoding and decoding efficiency may be improved.

### BRIEF DESCRIPTION OF THE DRAWINGS

FIG. 1 is a block diagram illustrating a configuration of a video encoding apparatus according to an embodiment of the present invention.

FIG. 2 is a block diagram illustrating a configuration of a video decoding apparatus according to an embodiment of the present invention.

FIG. 3 is a conceptual diagram schematically illustrating an embodiment of a scalable video coding structure using a plurality of layers to which the present invention may be applied.

FIG. 4 is a diagram illustrating a target block and a reference block according to an embodiment of the present invention.

FIG. 5 is a control flowchart for describing a method of encoding a second layer with reference to a first layer in an encoding apparatus according to the present invention.

FIG. 6 is a control flowchart for describing a method of decoding a second layer with reference to a first layer in a decoding apparatus according to the present invention.

### DETAILED DESCRIPTION OF THE EMBODIMENTS

Hereinafter, embodiments of the present invention are described in detail with reference to the accompanying drawings. In describing the embodiments of the present invention, a detailed description of related known elements or functions will be omitted if it is deemed to make the gist of the present invention unnecessarily vague. ‘coupled’ with the other element, it may mean that the one element may be directly connected or coupled with the other element and a third element may be ‘connected’ or ‘coupled’ between the two elements. Furthermore, in this specification, when it is said that a specific element is ‘included’, it may mean that elements other than the specific element are not excluded and that additional elements may be included in the embodiments of the present invention or the scope of the technical spirit of the present invention.

Terms, such as the first and the second, may be used to describe various elements, but the elements are not restricted by the terms. The terms are used to only distinguish one element from the other element. For example, a first element may be named a second element without departing from the scope of the present invention. Likewise, a second element may be named a first element.

Further, components described in the embodiments of the present invention are independently illustrated in order to show different characteristic functions and each component is not constituted by separated hardware or one software constituting unit. That is, each component includes the respective components that are arranged for easy description, and at least two components among the respective components are combined to form one component or one component is divided into a plurality of components to perform its function, and integrated exemplary embodiments and separated exemplary embodiments of each component are also included in the scope of the present invention without departing from the spirit of the present invention.

Further, some components are not requisite components that perform essential functions but selective components for just improving performance in the present invention. The present invention may be implemented by only components required to implement the spirit of the present invention other than components used for performance improvement and a structure including only required components other than optional components just used for performance improvement is also included in the scope of the present invention.

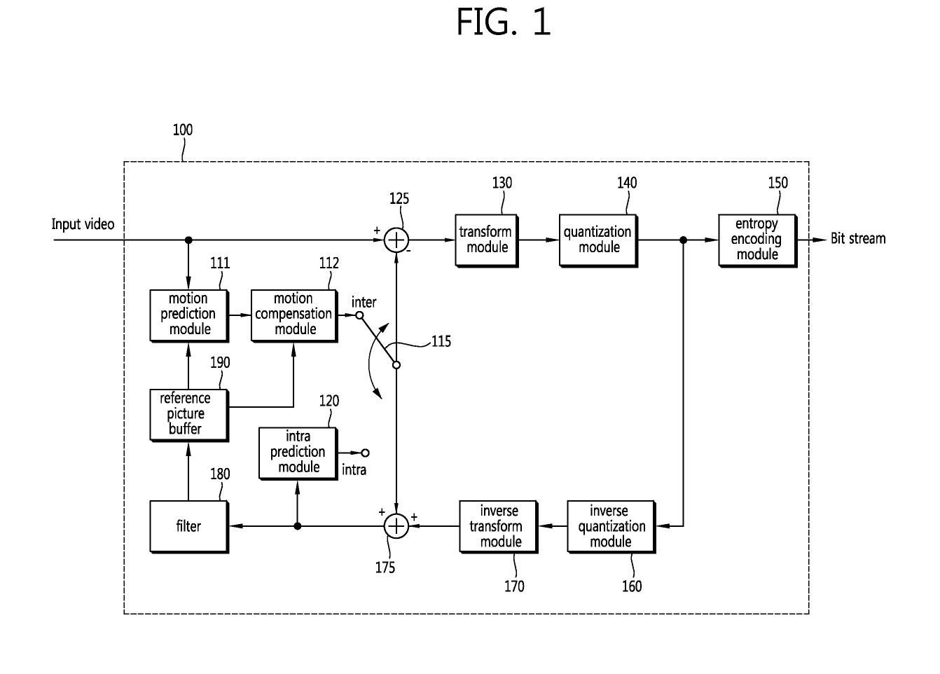

FIG. 1 is a block diagram illustrating a configuration of a video encoding apparatus according to an embodiment of the present invention. A scalable video encoding/decoding method or apparatus may be implemented by extension of a general video encoding/decoding method or apparatus without providing scalability, and the block diagram of FIG. 1 illustrates an embodiment of a video encoding apparatus which may form a basis of a scalable video encoding apparatus.

Referring to FIG. 1, the video encoding apparatus 100 includes a motion prediction module 111, a motion compensation module 112, an intra prediction module 120, a switch 115, a subtractor 125, a transformation module 130, a quantization module 140, an entropy encoding module 150, an inverse quantization module 160, an inverse transformation module 170, an adder 175, a filter 180, and a reference video buffer 190.

The video encoding apparatus 100 may perform encoding in an intra mode or an inter mode with respect to an input video and output a bit stream. The intra prediction means prediction in a picture, and the inter prediction means prediction between pictures. In the intra mode, the switch 115 is shifted to the intra mode, and in the inter mode, the switch 115 is shifted to the inter mode. The video encoding apparatus 100 generates a prediction block for an input block of the input video, and then may encode a difference between the input block and the prediction block.

In the intra mode, the intra prediction module 120 performs spatial prediction by using a pixel value of a pre-encoded block around a current block to generate the prediction block.

In the case of the inter mode, the motion prediction module 111 may find a region which is best matched with the input block in the reference video stored in the reference video buffer 190 during the motion prediction process. The motion compensation module 112 compensates for the motion by using the motion vector and the reference video stored in the reference video buffer 190 to generate the prediction block.

The subtractor 125 may generate a residual block by the difference between the input block and the generated prediction block. The transform unit 130 performs transform for the residual block to output a transform coefficient. In addition, the quantization module 140 quantizes the input transform coefficient according to a quantization parameter to output a quantized coefficient.

The entropy encoding module 150 may entropy-encode a symbol according to probability distribution to output a bit stream, based on values calculated by the quantization module 140 or an encoding parameter value and the like calculated during the encoding process. The entropy encoding method is a method in which symbols having various values are received and expressed by decodable binary strings while removing statistical redundancy.

Here, the symbol means a syntax element to be encoded/decoded, a coding parameter, a value of a residual signal, and the like. The coding parameter is a parameter required for encoding and decoding, and may include information encoded in the encoding apparatus to be transferred to the decoding apparatus like the syntax element and information to be inferred during the encoding or decoding process, and means information required when encoding and decoding the video. For example, the coding parameter may include values or statistics of an intra/inter-prediction mode, a movement/motion vector, a reference video index, a coding block pattern, presence of a residual signal, a transform coefficient, a quantized transform coefficient, a quantized parameter, a block size, block division information, and the like. Further, the residual signal may mean a difference between an original signal and a prediction signal, and further, may also mean a signal in which the difference between the original signal and the prediction signal is transformed, or a signal in which the difference between the original signal and the prediction signal is transformed and quantized. The residual signal may be referred to as a residual block in a block unit.

In the case of applying the entropy encoding, a few of bits are allocated to a symbol having high occurrence probability, and a lot of bits are allocated to a symbol having low occurrence probability to express the symbol, and as a result, a size of bit steams for symbols to be encoded may be reduced. Accordingly, compression performance of video encoding may be enhanced through the entropy encoding.

For the entropy encoding, encoding methods, such as exponential golomb, context-adaptive variable length coding (CAVLC), and context-adaptive binary arithmetic coding (CABAC), may be used. For example, a table for performing the entropy encoding such as a variable length coding/code (VLC) table may be stored in the entropy encoding module 150, and the entropy encoding module 150 may perform the entropy encoding by using the stored VLC table. Further, the entropy encoding module 150 deducts a binarization method of a target symbol and a probability model of a target symbol/bin, and then may also perform the entropy encoding by using the deducted binarization method or probability model.

The quantized coefficient may be inversely quantized in the inverse quantization module 160 and inversely transformed in the inverse transform module 170. The inversely quantized and inversely transformed coefficient is added to the prediction block by the adder 175 to generate a restore block.

The reconstructed block passes though the filter 180, and the filter 180 may apply at least one of a deblocking filter, a sample adaptive offset (SAO), and an adaptive loop filter (ALF) to the reconstructed block or a restore picture. The reconstructed block passing through the filter 180 may be stored in the reference video buffer 190.

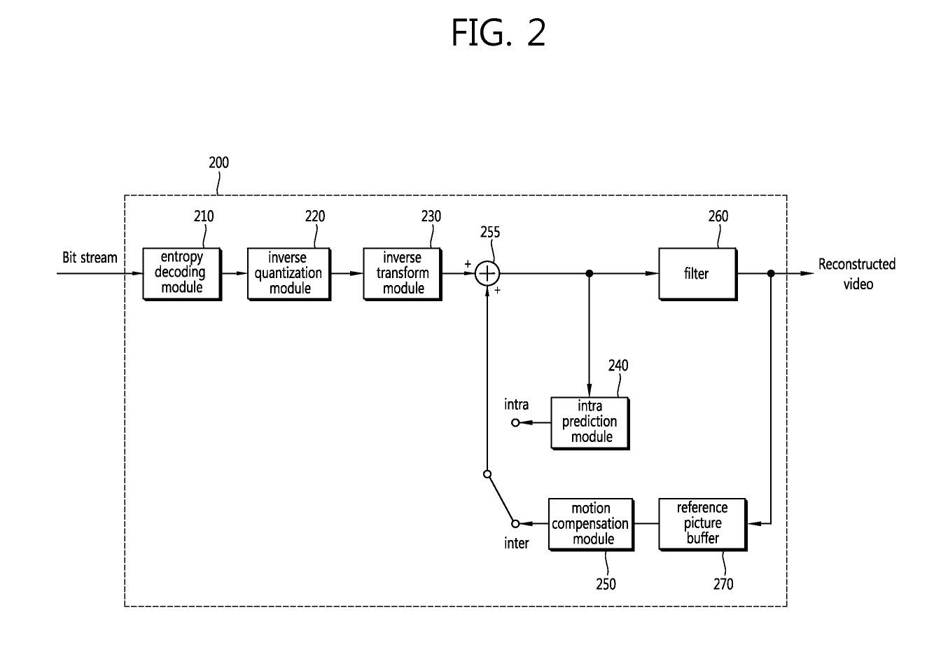

FIG. 2 is a block diagram illustrating a configuration of a video decoding apparatus according to an embodiment of the present invention. As above- described in FIG. 1, a scalable video encoding/decoding method or apparatus may be implemented by extension of a general video encoding/decoding method or apparatus without providing scalability, and the block diagram of FIG. 2 illustrates an embodiment of a video decoding apparatus which may form a basis of a scalable video encoding apparatus.

Referring to FIG. 2, the video decoding apparatus 200 includes an entropy decoding module 210, an inverse quantization module 220, an inverse transform module 230, an intra prediction module 240, a motion compensation module 250, a filter 260, and a reference video buffer 270.

The video decoding apparatus 200 receives a bit stream output from the encoding apparatus to perform decoding in an inter mode or an inter mode and output a reconfigured video, that is, a restore video. In the case of the intra mode, the switch may be shifted to the intra mode, and in the case of the inter mode, the switch may be shifted to the inter mode. The video decoding apparatus 200 may acquire a residual block restored from the input bit stream and generate a prediction block, and then generate a reconfigured block, that is, a reconstructed block by adding the restored residual block and the prediction block.

The entropy decoding module 210 entropy-decodes the input bit stream according to probability distribution to generate symbols including a symbol having a quantized coefficient form. The entropy decoding method is a method of receiving binary strings to generate respective symbols. The entropy decoding method is similar to the aforementioned entropy encoding method.

The quantized coefficient is inversely quantized in the inverse quantization module 220 and inversely transformed in the inverse transform module 230, and as a result, when the quantized coefficient is inversely quantized and inversely transformed, a restored residual block may be generated.

In the case of the intra mode, the intra prediction module 240 performs spatial prediction by using a pixel value of a pre-encoded block around a current block to generate a prediction block. In the case of the inter mode, the motion compensation module 250 compensate for the motion by using the motion vector and the reference video stored in the reference video buffer 270 to generate the prediction block.

The restored residual block and the prediction block are added through the adder 255, and the added blocks pass through the filter 260. The filter 260 may apply at least one of a deblocking filter, an SAO, and an ALF to the reconstructed block or the restore picture. The filter 260 outputs the reconfigured video, that is, the restore video. The restore video may be stored in the reference video buffer 270 to be used for prediction between pictures.

The constituent elements directly related to the video decoding among the entropy decoding module 210, the inverse quantization module 220, the inverse transform module 230, the intra prediction module 240, the motion compensation module 250, the filter 260, and the reference video buffer 270 included in the video decoding apparatus 200, for example, the entropy decoding module 210, the inverse quantization module 220, the inverse transform module 230, the intra prediction module 240, the motion compensation module 250, the filter 260, and the like are distinguished from other constituent elements to be expressed by the decoding unit.

Further, the video decoding apparatus 200 may further include a parsing module (not illustrated) parsing information regarding the encoded video included in the bit stream. The parsing module may include the entropy decoding module 210, and may also be included in the entropy decoding module 210. The parsing module may be further implemented as one constituent element of the decoding module.

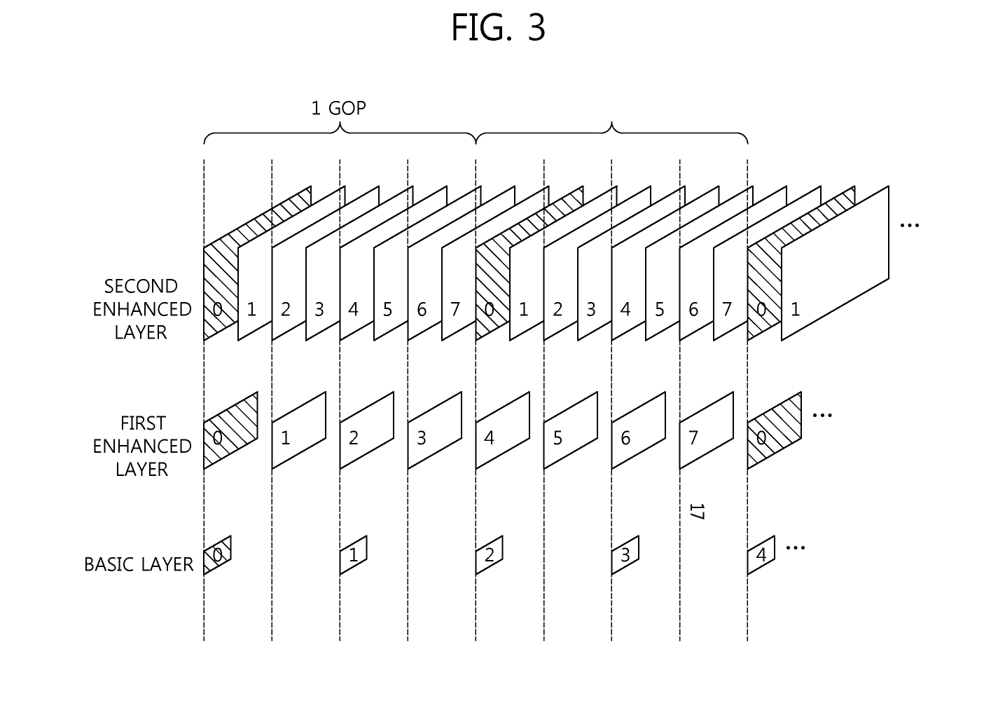

FIG. 3 is a conceptual diagram schematically illustrating an embodiment of a scalable video coding structure using a plurality of layers to which the present invention may be applied. In FIG. 3, a group of picture (GOP) represents a picture group.

In order to transmit the video data, a transmission medium is required, and performance thereof is different for each transmission medium according to various network environments. For application to various transmission media or network environments, the scalable video coding method may be provided.

The scalable video coding method is a coding method in which redundancy between layers is removed by using texture information between the layers, motion information, a residual signal, and the like to improve encoding/decoding performance. The scalable video coding method may provide various scalabilities in spatial, temporal, and quality aspects, according to ambient conditions such as a transmission bit rate, a transmission error rate, and a system resource.

The scalable video coding may be performed by using a multiple layers structure so as to provide a bit stream which can be applied to various network situations. For example, the scalable video coding structure may include a basic layer of compressing and processing the video data by using a general video encoding method, and my include an enhanced layer of compressing and processing the video data by using coding information of the basic layer and the general video encoding method.

Here, the layer means a set of videos and bitstreams divided based on spatiality (for example, a video size), temporality (for example, a coding order, a video output order, a frame rate), quality, complexity, and the like. Further, the basic layer may mean a lower layer, a reference layer, or a base layer, and the enhanced layer may mean an upper layer, and an enhancement layer. Further, the plurality of layers may have dependency between the layers.

Referring to FIG. 3, for example, the basic layer may be defined as standard definition (SD), a frame rate of 15 Hz, and a bit rate of 1 Mbps, and a first enhanced layer may be defined as high definition (HD), a frame rate of 30 Hz, and a bit rate of 3.9 Mbps, and a second enhanced layer may be defined as ultra high definition (4K-UHE), a frame rate of 60 Hz, and a bit rate of 27.2 Mbps. The format, the frame rate, the bit rate, and the like may vary if necessary, as one embodiment. Further, the number of used layers is not limited to the embodiment, but may vary according to a situation.

For example, when the transmission bandwidth is 4 Mbps, the frame rate of the first enhanced layer HD is reduced to be transmitted at 15 Hz or less. The scalable video coding method may provide spatial, temporal, and quality scalabilities by the method described in the embodiment of FIG. 3.

In the case of the video encoding and decoding supporting the plurality of layers in the bitstream, that is, the scalable coding, since there is strong correction between the plurality of layers, the prediction is performed by using the correction to remove redundant elements of the data and improve encoding performance of the video. Performing prediction of a current layer to be predicted by using information of other layers is hereinafter expressed as inter-layer prediction. Hereinafter, the scalable video coding means a scalable video encoding in terms of encoding, and has the same mean as the scalable video decoding in terms of decoding.

In the plurality of layers, at least one of resolution, a frame rate, and a color format may be different from each other, and during the inter-layer prediction, up-sampling and down-sampling of the layers may be performed in order to control the resolution.

During the inter-layer prediction of predicting the upper layer by using information of the lower layer, inter-layer texture prediction, inter-layer motion prediction, inter-layer syntax prediction, and the like may be performed by using a texture of the lower layer, prediction mode information in a picture, motion information, syntax information, and the like.

The inter-layer texture prediction means using the texture of the reference block in the lower layer as a prediction value (prediction sample) of the current block of the upper layer, and in this case, the texture of the reference block may be scheduled by up-sampling.

The inter-layer texture prediction may be approached by an intraBL mode in which a restored value of the reference block in the lower layer is up-sampled, and the up-sampled reference block is used as a prediction value for the current block to encode a residual value with the current block, and approached by a reference index mode in which the up-sampled lower layer is stored in a memory, and the stored lower layer is used as a reference index.

Hereinafter, for convenience of description, the upper layer to which the target block to be encoded and decoded belongs is expressed as a second layer, and the lower layer referred by the second layer is expressed as a first layer.

An object of the present invention is to perform inter-layer texture prediction by determining existence of the inter-layer texture prediction according to a size of an encoded/decoded target block of the second layer, remove redundancy for texture information between the layers, and improve coding efficiency.

When the inter-layer texture prediction for the encoding/decoding target block of the second layer is performed, the encoding apparatus performs the inter-layer texture prediction for all block sizes and then may determine an encoding

Further, the decoding apparatus parses an inter-layer texture prediction indicator with respect to all the block sizes and then may determine a usage of the inter-layer texture prediction.

However, in the case where the size of the video is increased and various block sizes are used, when the inter-layer texture prediction for all block sizes is performed, in the encoding apparatus, complexity tends to be increased, and when the inter-layer texture prediction indicator is entropy-encoded and decoded, there is a problem in that encoding efficiency may deteriorate due to irregular occurrence probability.

As a result, in order to solve the aforementioned problems according to the embodiment of the present invention, the inter-layer texture prediction may need to be performed only when the size of the encoding/decoding target block of the second layer is included within a specific range.

As such, when the size of the encoding/decoding target block is limited, an increase in complexity according to various block sizes may be reduced, and when the inter-layer texture prediction indicator is entropy-encoded and decoded, occurrence probability becomes regular, thereby improve encoding/decoding efficiency.

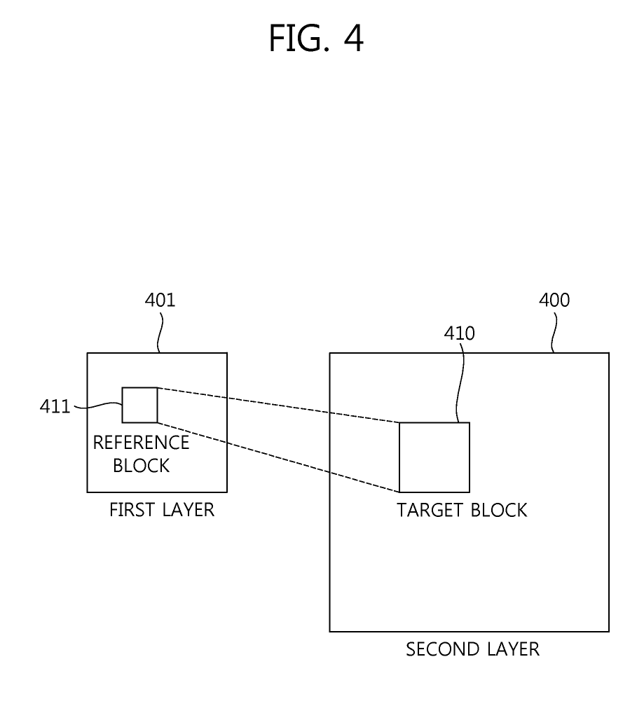

FIG. 4 is a diagram illustrating a target block and a reference block according to an embodiment of the present invention. For convenience of description, a first layer 401 corresponding to a target block 410 of a second layer 400 is represented as a reference block 411. The target block 410 according to the present invention may be a coding block, a prediction block, or a transform block.

When prediction of the target block is performed by using information on a restore value of the first layer 401, a position of the reference block 411 may be determined according to a resolution ratio of the second layer 400 and the first layer 401. That is, a coordinate specifying the position of the target block 410 may correspond to a specific coordinate of the first layer 401 according to a resolution ratio. The reference block 411 may include one prediction unit, or a plurality of prediction units.

The encoding apparatus may include an encoding module for encoding the first layer 401 and an encoding module for encoding the second layer 400, and in this case, the configuration of the video encoding apparatus of FIG. 1 may be included in the two encoding modules, respectively.

The decoding apparatus may include a decoding module for decoding the first layer 401 and a decoding module for decoding the second layer 400, and in this case, the configuration of the video decoding apparatus of FIG. 2 may be included in the two decoding modules, respectively.

The encoding apparatus and the decoding apparatus may be used to generate the restore value of the reference block 411 as a prediction value for the target block 410. In this case, the encoding apparatus and the decoding apparatus may schedule the restore value of the reference block 411 by up-sampling.

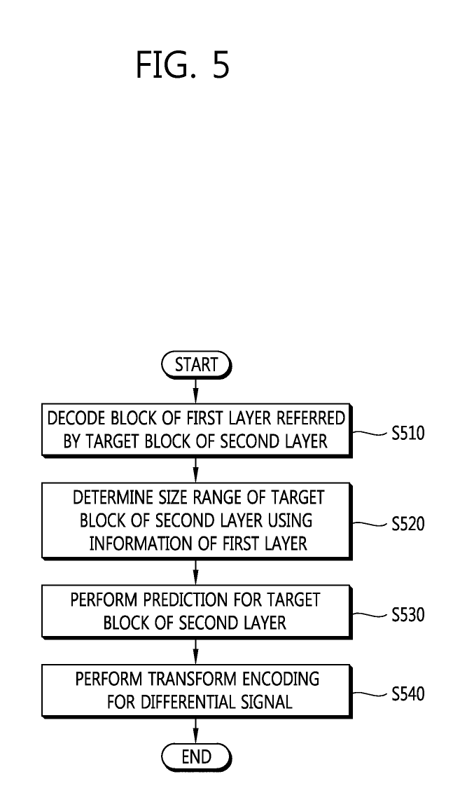

FIG. 5 is a control flowchart for describing a method of encoding a second layer with reference to a first layer in an encoding apparatus according to the present invention.

Referring to FIG. 5, first, an encoding apparatus decodes a block of a first layer referred by a target block of a second layer (S510).

The block of the first layer referred by the target block of the second layer may be decoded according to an encoding method of a reference layer to be transmitted in video parameter sets (VPS), sequence parameter sets (SPS), and the like.

For example, the encoding apparatus may decode the block of the first layer according to an MPEG-2 method, when the reference layer is encoded by the MPEG-2 method.

Further, the encoding apparatus may decode the block of the first layer according to an H.264/AVC method, when the reference layer is encoded by the H.264/AVC method.

Further, when the reference layer is encoded by an HEVC method, the encoding apparatus may decode the block of the first layer according to the HEVC method.

The first layer and the second layer may be processed in respective encoding modules which encode the respective layer as described above, and the first layer may be predicted and restored earlier than the second layer to be encoded.

The decoded first layer may be stored in a memory such as a decoded picture buffer (DPB). The stored first layer may be referred by the second layer and then removed from the memory, and stored in the memory for a predetermined time.

When the block of the first layer is decoded, the encoding apparatus may determine a size range of the target block of the second layer which may use information of the first layer (S520).

When the encoding apparatus determines the size range of the target block, various methods may be applied.

According to the embodiment of the present invention, the encoding apparatus may determine the size range of the target block of the second layer so as to use the information of the first layer with respect to all predetermined allowable block sizes.

For example, in the case where the predetermined allowable size range of the block is from 64×64 to 8×8, the encoding apparatus may determine the size range of the target block which may use a decoded block signal of the first layer as 64×64 to 8×8.

Further, in the case where the predetermined allowable size range of the block is from 64×64 to 16×16, the encoding apparatus may determine the size range of the target block which may use a decoded block signal of the first layer as 64×64 to 16×16.

Further, the encoding apparatus may determine the size range of the target block of the second layer so as to use the information of the first layer with respect to all allowable block sizes which are defined by the encoding apparatus.

According to another embodiment of the present invention, the encoding apparatus may determine the size range of the target block of the second layer which may use the information of the first layer according to an implicit rule with the decoding apparatus.

For example, the encoding apparatus may limit the size range of the target block which may use the information of the first layer according to an implicit rule with the decoding apparatus as one size such as 64×64 or 8×8.

Further, the encoding apparatus may determine the size range of the target block which may use the information of the first layer as a range of a maximum value and a minimum value such as 8×8 or more and 32×32 or less, 16×16 or less, or 16×16 or more.

Further, the encoding apparatus may determine the size range of the target block which may use the information of the first layer as a maximum block size which is allowable in the encoding apparatus or a minimum block size which is allowable in the encoding apparatus.

Further, the encoding apparatus may set various size ranges according to an implicit rule with the encoding apparatus other than the aforementioned size or size range of the target block, or change the set size or size range of the target block.

In the case where the size range of the target block of the second layer which may use the information of the first layer is determined according to the implicit rule between the decoding apparatus and the encoding apparatus, the encoding apparatus may signal the size range of the target block which may use the decoded block signal of the first layer through a separate indicator.

The encoding apparatus may include and encode information which may distinguish a minimum size and a maximum size of the block in sequence parameter sets (SPS), picture parameter sets (PPS), a slice header, and the like.

For example, the encoding apparatus may signal the minimum size or maximum size information of the block by using a syntax element, such as log2_min_luma_intrabl_size_minus3, log2_max_luma_intrabl_size_minus3, log2_max_luma_intrablskip_size_minus3, and log2_max_luma_intrablskip_size_minus3.

Further, the encoding apparatus may express and encode maximum size information of the target block of the second layer which may use the information of the first layer as a difference value for the minimum block size. For example, the encoding apparatus may signal the maximum size information of the target block by using a syntax element, such as log2_diff_max_min_luma_intrabl_size, and log2_diff_max_min_luma_intrablskip_size.

As another example, the encoding apparatus may also express and signal the maximum/minimum size information of an allowable block as a difference value (delta) between the minimum size and the maximum size information (for example, log2_min_luma_coding_block_size_minus3 or log2_diff_max_min_luma_coding_block_size) defined in the encoding apparatus signaled in the SPS.

As such, in the case where the encoding apparatus according to the present invention performs the inter-layer texture prediction, only when the size of the encoding target block of the second layer is included in a specific range, the inter-layer texture prediction may be performed, and as a result, the increase of complexity may be reduced, and when the inter-layer texture prediction indicator is entropy-encoded and decoded, the occurrence probability may become regular. Accordingly, it is possible to improve the encoding efficiency of the video.

When the size range of the target block of the second layer which may use the information of the first layer is determined, the encoding apparatus may perform the prediction for the target block (S530). That is, in the case where the size of the target block to be encoded corresponds to the block size range determined by any one method of the many methods, the encoding apparatus may perform prediction for the target block by using the decoded block signal of the first layer.

The encoding apparatus may perform intraBL prediction which uses the decoded block signal of the first layer as the prediction signal with a differential signal of the target block of the second layer. That is, the encoding apparatus may up-sample the restored value of the reference block in the first layer and use the up-sampled restore value as a prediction value of the target block.

In the case where the size range of the target block of the second layer which may use the information of the first layer is an allowable range (for example, 64×64 to 8×8) defined in the encoding apparatus, the encoding apparatus may perform the intraBL prediction in the sizes 64×64 to 8×8 of all the target blocks of the second layer.

Further, in the case where the size range of the target block of the second layer which may use the information of the first layer is limited to a specific size such as 64×64, the encoding apparatus may perform the intraBL prediction with respect to only the block of the specific size like the case where the size of the target block of the second layer is 64'64.

Further, in the case where the size range of the target block of the second layer which may use the information of the first layer is determined as a specific range, such as for example, 32×32 or less or 8×8 or more, the encoding apparatus may perform the intraBL prediction only when the size of the target block of the second layer is included in the determined block size range.

As another example, in the case where the determined block size range is 16×16 or less, only when the size of the target block of the second layer is smaller than or equal to 16×16, the encoding apparatus may perform the intraBL prediction with respect to the target block.

Further, when the size range of the target block of the second layer which may use the information of the first layer is determined as a minimum block size which is allowable in the encoding apparatus, the encoding apparatus may perform the intraBL prediction only when the size of the target block of the second layer is the minimum block size.

Further, when the size range of the target block of the second layer which may use the information of the first layer is determined as a maximum block size which is allowable in the encoding apparatus, the encoding apparatus may perform the intraBL prediction only when the size of the target block of the second layer is the maximum block size.

According to another embodiment, the encoding apparatus may perform intraBL_skip prediction in which the decoded block signal of the first layer is used as a prediction signal without a differential signal of the target block of the second layer. According to the intraBL_skip prediction, the restored value of the reference block in the first layer is up-sampled, and the up-sampled restore value may be used as the restore value of the target block.

In the case where the size range of the target block of the second layer which may use the information of the first layer is an allowable range (for example, 64×64 to 8×8) defined in the encoding apparatus, the encoding apparatus may perform the intraBL_skip prediction in the sizes 64×64 to 8×8 of all the target blocks of the second layer.

Further, in the case where the size range of the target block of the second layer which may use the information of the first layer is limited to a specific size such as 64×64, the encoding apparatus may perform the intraBL_skip prediction with respect to only the block of the specific size like the case where the size of the target block of the second layer is 64×64.

Further, in the case where the size range of the target block of the second layer which may use the information of the first layer is determined as a specific range, such as for example, 32×32 or less or 8×8 or more, the encoding apparatus may perform the intraBL_skip prediction only when the size of the target block of the second layer is included in the determined block size range.

As another example, in the case where the determined block size range is 16×16 or less, only when the size of the target block of the second layer is smaller than or equal to 16×16, the encoding apparatus may perform the intraBL_skip prediction with respect to the target block.

Further, when the size range of the target block of the second layer which may use the information of the first layer is determined as a minimum block size which is allowable in the encoding apparatus, the encoding apparatus may perform the intraBL_skip prediction only when the size of the target block of the second layer is the minimum block size.

Further, when the size range of the target block of the second layer which may use the information of the first layer is determined as a maximum block size which is allowable in the encoding apparatus, the encoding apparatus may perform the intraBL_skip prediction only when the size of the target block of the second layer is the maximum block size.

When the encoding apparatus performs the intraBL prediction or the intraBL_skip prediction with respect to the target block, the size ranges of the target blocks of the second layer which may use the information of the first layer may be equally set or may be differently set.

When the sizes of the target blocks of the second layer which may use the information of the first layer to which the intraBL prediction and the intraBL_skip prediction may be applied are the same as each other, the encoding apparatus may also signal size information by using one syntax element.

On the contrary, like the case where the intraBL prediction is performed in all the block sizes regardless of the size of the target block of the second layer and the intraBL_skip prediction is performed only the block size of 32×32 or less, the size ranges of the target blocks of the second layer which may use the information of the first layer may be different from each other in the intraBL prediction and the intraBL_skip prediction, and in this case, the size information of the target block to which the prediction is applied may be signaled as different syntax elements.

Meanwhile, when the size of the target block is not included in the determined block size range, or the target block is not predicted by the inter-layer prediction, the encoding apparatus may perform general inter-picture prediction or intra-picture prediction by using a decoded video of the second layer or a decoded peripheral block of the target block.

As described above, when whether the decoded block signal of the first layer corresponding to the size of the target block is determined, the encoding apparatus may encode an indicator which indicates the inter-layer prediction for each target block to transmit the encoded indicator to the decoding apparatus.

For example, when the decoded block signal of the first layer may be used as the prediction signal with the differential signal, that is, when the intraBL prediction may be applied to the target block, the encoding apparatus encodes a flag such as an intra_bl_flag to report whether the intraBL prediction is applied to the decoding apparatus.

Further, when the decoded block signal of the first layer may be used as the prediction signal without the differential signal, that is, when the intraBL_skip prediction may be applied to the target block, the encoding apparatus encodes a flag such as an intra_bl_skip_flag to transmit information regarding whether the intraBL_skip prediction is applied to the decoding apparatus.

The encoding apparatus performs transform encoding for the differential signal of the target block in which the prediction is completed (S540).

When the intraBL prediction is performed in the target block, the encoding apparatus may generate a differential signal between an original video signal of the target block of the second layer and the decoded block signal of the first layer, and then perform the transform encoding with respect to the differential signal.

The encoding apparatus may perform the transform encoding according to transform depth information (for example, max_transform_hierarchy_depth_inter) defined for the inter-picture prediction, when the transform encoding is performed with respect to the differential signal of the target block to which the inter-picture prediction is applied.

Further, the encoding apparatus may perform the transform encoding according to transform depth information (for example, max_transform_hierarchy_depth_intra) defined for the intra-picture prediction, when the transform encoding is performed with respect to the differential signal of the target block to which the intra-picture prediction is applied.

Meanwhile, when the transform encoding is performed with respect to the differential signal of the target block to which the aforementioned intraBL prediction is applied, the encoding apparatus may perform the transform encoding according to any one of transform depth information (for example, max_transform_hierarchy_depth_inter) defined for the inter-picture prediction, transform depth information (for example, max_transform_hierarchy_depth_intra) defined for the intra-picture prediction, and third transform depth information (for example, max_transform_hierarchy_depth_intrabl) rather than the transform depth information (for example, max_transform_hierarchy_depth_inter) defined for the inter-picture prediction and the transform depth information (for example, max_transform_hierarchy_depth_intra) defined for the intra-picture prediction.

The third transform depth information (for example, max_transform_hierarchy_depth_intrabl) may be encoded as a difference (delta) value from the intra or inter-picture transform depth information.

The transform depth information defined for the inter-picture prediction, the transform depth information defined for the intra-picture prediction, and the third transform depth information may be defined in the sequence parameter sets (SPS) to be signaled.

Meanwhile, when the target block of the second layer is a block to which the prediction without the differential signal, that is, the intraBL_skip prediction is applied, the encoding apparatus may omit the transform encoding and the quantization.

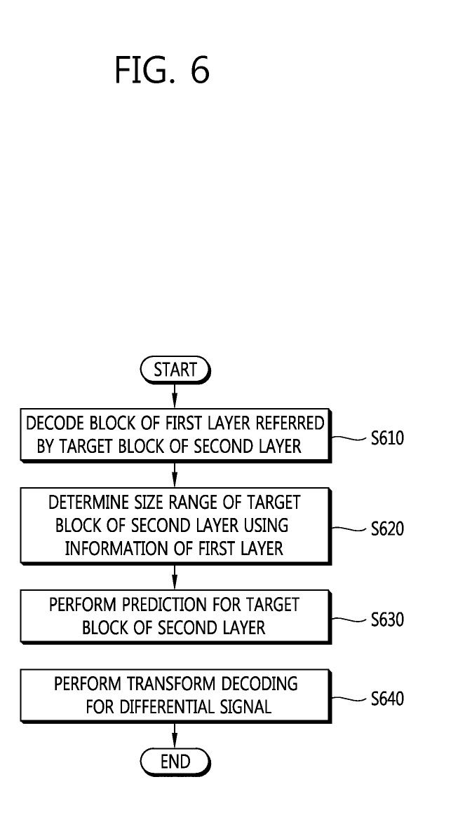

FIG. 6 is a control flowchart for describing a method of decoding a second layer with reference to a first layer in a decoding apparatus according to the present invention.

First, the decoding apparatus decodes a block of a first layer referred by a target block of a second layer (S610).

The block of the first layer referred by the target block of the second layer may be decoded according to an encoding method of a reference layer to be transmitted in video parameter sets (VPS), sequence parameter sets (SPS), and the like.

For example, the decoding apparatus may decode the block of the first layer according to an MPEG-2 method, when the reference layer is encoded by the MPEG-2 method.

Further, the decoding apparatus may decode the block of the first layer according to an H.264/AVC method, when the reference layer is encoded by the H.264/AVC method.

Further, when the reference layer is encoded by an HEVC method, the decoding apparatus may decode the block of the first layer according to the HEVC method.

The first layer and the second layer may be processed in respective decoding modules, and the first layer may be predicted and restored earlier than the second layer.

The decoded first layer may be stored in a memory such as a decoded picture buffer (DPB). The stored first layer may be referred by the second layer and then removed from the memory, and stored in the memory for a predetermined time.

When the block of the first layer is decoded, the decoding apparatus may determine a size range of the target block of the second layer which may use information of the first layer (S620).

When the decoding apparatus determines the size range of the target block, various methods may be applied.

According to the embodiment of the present invention, the decoding apparatus may determine the size range of the target block of the second layer so as to use the information of the first layer with respect to all predetermined allowable block sizes.

For example, in the case where the predetermined allowable size range of the block is from 64×64 to 8×8, the decoding apparatus may determine the size range of the target block which may use a decoded block signal of the first layer as 64×64 to 8×8.

Further, in the case where the predetermined allowable size range of the block is from 64×64 to 16×16, the decoding apparatus may determine the size range of the target block which may use a decoded block signal of the first layer as 64×64 to 16×16.

Further, the decoding apparatus may determine the size range of the target block of the second layer so as to use the information of the first layer with respect to all allowable block sizes which are defined by the encoding apparatus.

According to another embodiment of the present invention, the decoding apparatus may determine the size range of the target block of the second layer which may use the information of the first layer according to an implicit rule between the encoding apparatuses.

For example, the decoding apparatus may limit the size range of the target block which may use the information of the first layer according to an implicit rule between the encoding apparatuses as one size such as 64×64 or 8×8.

Further, the decoding apparatus may determine the size range of the target block which may use the information of the first layer as a range of a maximum value and a minimum value such as 8×8 or more and 32×32 or less, 16×16 or less, or 16×16 or more.

Further, the decoding apparatus may determine the size range of the target block which may use the information of the first layer as a maximum block size which is allowable in the encoding apparatus or a minimum block size which is allowable in the encoding apparatus.

Further, the decoding apparatus may set various size ranges according to an implicit rule with the encoding apparatus other than the size or the size range of the target block described above.

The encoding apparatus may signal the size range of the target block which may use the decoded block signal of the first layer through a separate indicator, and the decoding apparatus parses information transmitted from the encoding apparatus to determine the size range of the target block of the second layer.

The decoding apparatus parses information which may distinguish the minimum size of the block and maximum size information of the block included in sequence parameter sets (SPS), picture parameter sets (PPS), a slice header, and the like to determine the size range of the target block which may use the decoded block signal of the first layer.

For example, the minimum size or the maximum size information of the target block which may use the decoded block signal of the first layer may be signaled by using a syntax element, such as log2_min_luma_intrabl_size_minus3, log2_max_luma_intrabl_size_minus3, log2_max_luma_intrablskip_size_minus3, and log2_max_luma_intrablskip_size_minus3.

Further, the maximum size information of the target block of the second layer which may use the information of the first layer may be expressed and signaled as a difference value for the minimum block size.

For example, the decoding apparatus may parse a syntax element such as log2_diff_max_min_luma_intrabl_size, and log2_diff max min_luma_intrablskip_size to use an added value to the minimum block size as the maximum size information of the target block.

As another example, the encoding apparatus may also express and signal the maximum/minimum size information of an allowable block as a difference value (delta) between the minimum size and the maximum size information (for example, log2_min_luma_coding_block_size_minus3 or log2_diff max_min_luma_coding_block_size) defined in the encoding apparatus signaled in the SPS. In this case, the decoding apparatus parses the difference value to add the difference value to the minimum size and the maximum size defined in the encoding apparatus and then determine the difference value as the maximum block size or the minimum block size of the target block of the second layer which may use the information of the first layer.

As such, in the case where the decoding apparatus according to the present invention performs the inter-layer texture prediction, only when the size of the target block of the second layer is included in a specific range, the inter-layer texture prediction is performed, thereby improving video decoding efficiency.

Next, the decoding apparatus performs the prediction for the target block of the second layer (S630). When the target block to perform the decoding corresponds to the determined block size range using the decoded block signal of the first layer, the decoding apparatus parses an intra_bl_flag or an intra_bl_skip_flag to perform the intraBL prediction or the intraBL_skip prediction using the decoded block signal of the first layer.

The decoding apparatus parses an inter-layer prediction indicator (for example, intra_bl_flag) when the target block has a size allowing the intraBL prediction, and then when the flag has a value of 1, the decoding apparatus may perform the intraBL prediction in which the decoded block signal of the first layer is used as the prediction signal with the differential signal of the target block of the second layer. That is, the decoding apparatus may up-sample the restored value of the reference block in the first layer and use the up-sampled restore value as a prediction value of the target block with the differential signal.

In the case where the size range of the target block of the second layer which may use the information of the first layer is an allowable range (for example, 64×64 to 8×8) defined in the encoding apparatus, the decoding apparatus may parse the intra_bl_flag in the sizes 64×64 to 8×8 of all the target blocks of the second layer. When the intra_bl_flag is 1, the decoding apparatus may use the decoded block signal of the first layer as the prediction signal according to the intraBL prediction with respect to the corresponding block.

Further, in the case where the size range of the target block of the second layer which may use the information of the first layer is limited to a specific size such as 64×64, the decoding apparatus may parse the intra_bl_flag with respect to only the block of the specific size like the case where the size of the target block of the second layer is 64×64. When the intra_bl_flag is 1, the decoding apparatus may use the decoded block signal of the first layer as the prediction signal with respect to the corresponding block.

Further, the decoding apparatus may parse the intra_bl_flag, when the size range of the target block of the second layer which may use the information of the first layer is determined as a specific range such as, for example, 32×32 or less or 8×8 or more. Only when the intra_bl_flag is 1, the decoding apparatus may use the decoded block signal of the first layer as the prediction signal for the corresponding block.

As another example, in the case where the determined block size range is 16×16 or less, only when the size of the target block of the second layer is smaller than or equal to 16×16, the decoding apparatus may parse the intra_bl_flag. Only when the intra_bl_flag is 1, the decoding apparatus may use the decoded block signal of the first layer as the prediction signal with respect to the block of which the size is smaller than or equal to 16×16.

Further, when the size range of the target block of the second layer which may use the information of the first layer is determined as a minimum block size which is allowable in the encoding apparatus, the decoding apparatus may parse the intra_bl_flag when the size of the target block of the second layer is the minimum block size. When the intra_bl_flag is 1, the decoding apparatus may use the decoded block signal of the first layer as the prediction signal with respect to the target block having the minimum block size.

Further, when the size range of the target block of the second layer which may use the information of the first layer is determined as a maximum block size which is allowable in the encoding apparatus, the decoding apparatus may parse the intra_bl_flag. When the intra_bl_flag is 1, the decoding apparatus may use the decoded block signal of the first layer as the prediction signal with respect to the target block having the maximum block size.

According to another embodiment, the decoding apparatus may also perform intraBL_skip prediction in which the decoded block signal of the first layer is used as a prediction signal without a differential signal of the target block of the second layer. According to the intraBL_skip prediction, the restored value of the reference block in the first layer is up-sampled, and the up-sampled restore value may be used as the restore value of the target block.

When the decoding apparatus parses an inter-prediction indicator (for example, intra_bl_skip_flag) and the has a value of 1 in the case where the target block has a block size allowing the intraBL_skip prediction, the decoded block signal of the first layer may be used as a prediction signal without the differential signal.

In the case where the size range of the target block of the second layer which may use the information of the first layer is an allowable range (for example, 64×64 to 8×8) defined in the encoding apparatus, the decoding apparatus may parse the intra_bl_skip_flag with respect to the sizes 64×64 to 8×8 of all the target blocks of the second layer. When the intra_bl_skip_flag is 1, the decoding apparatus may use the decoded block signal of the first layer as the prediction signal without the differential signal according to the intraBL_skip prediction with respect to the corresponding block.

Further, in the case where the size range of the target block of the second layer which may use the information of the first layer is limited to a specific size such as 64×64, the decoding apparatus may parse the intra_bl_skip_flag with respect to only the block of the specific size like the case where the size of the target block of the second layer is 64×64. When the intra_bl_skip_flag is 1, the decoding apparatus may use the decoded block signal of the first layer as the prediction signal without the differential signal with respect to the target block having the size of 64×64.

Further, in the case where the size range of the target block of the second layer which may use the information of the first layer is determined as a specific range, such as for example, 32×32 or less or 8×8 or more, the decoding apparatus may parse the intra_bl_skip_flag only when the size of the target block of the second layer is included in the determined block size range. Only when the intra_bl_skip_flag is 1, the decoding apparatus may use the decoded block signal of the first layer as the prediction signal without the differential signal with respect to the target block having the size of 32×32 or less or 8×8 or more.

As another example, in the case where the determined block size range is 16×16 or less, only when the size of the target block of the second layer is smaller than or equal to 16×16, the decoding apparatus may parse the intra_bl_skip_flag. When the intra_bl_skip_flag is 1, the decoding apparatus may use the decoded block signal of the first layer as the prediction signal without the differential signal with respect to the target block having the size of 16×16 or less.

Further, when the size range of the target block of the second layer which may use the information of the first layer is determined as a minimum block size which is allowable in the encoding apparatus, the decoding apparatus may parse the intra_bl_skip_flag only when the size of the target block of the second layer is the minimum block size. When the intra_bl_skip_flag is 1, the decoding apparatus may use the decoded block signal of the first layer as the prediction signal without the differential signal with respect to the target block having the minimum block size.

Further, when the size range of the target block of the second layer which may use the information of the first layer is determined as a maximum block size which is allowable in the encoding apparatus, the decoding apparatus may parse the intra_bl_skip_flag only when the size of the target block of the second layer is the maximum block size. When the intra_bl_skip_flag is 1, the decoding apparatus may use the decoded block signal of the first layer as the prediction signal without the differential signal with respect to the target block having the maximum block size.

When the intraBL prediction and the intraBL_skip prediction are performed, the allowable size ranges of the target blocks may be different from each other, and accordingly, the decoding apparatus may adaptively parse the intra_bl_flag or the intra_bl_skip_flag.

For example, the intraBL prediction is preformed in all the block sizes regardless of the size of the target block of the second layer, and the intraBL_skip prediction may be performed only in the case of 32×32 or less. When the size of a current decoding target block is 64×64, the intra_bl_flag may be parsed, and the intra_bl_skip_flag is not signaled in the encoding apparatus and thus may not be parsed.

Meanwhile, when the size of the target block is not included in the determined block size range, or the target block is not predicted by the inter-layer prediction, the decoding apparatus may perform general inter-picture prediction or intra-picture prediction by using a decoded video of the second layer or a decoded peripheral block of the target block.

When the prediction for the target block is completed, the decoding apparatus performs transform decoding for the differential signal (S640).

In the prediction of step S630, when the target block of the second layer may be determined as the prediction with the differential signal, that is, the intraBL prediction block, the decoding apparatus may perform inverse-transform decoding with respect to the differential signal of the second layer transmitted from the encoding apparatus.

When the inverse-transform decoding is performed, the decoding apparatus may perform inverse-transform decoding according to transform depth information (for example, max_transform_hierarchy_depth_inter) defined for inter-picture prediction.

When the inverse-transform decoding is performed, the decoding apparatus may perform the inverse-transform decoding according to transform depth information (for example, max_transform_hierarchy_depth_intra) defined for intra-picture prediction.

When the decoding apparatus according to another embodiment performs the inverse-transform decoding, the decoding apparatus may also the inverse-transform decoding according to third transform depth information (for example, max_transform_hierarchy_depth_intrabl) rather than the transform depth information (for example, max_transform_hierarchy_depth_inter) defined for inter- picture prediction and the transform depth information (for example, max_transform_hierarchy_depth_intra) defined for intra-picture prediction. The third transform depth information may be expressed by a sum of difference values (delta values) transmitted from the encoding apparatus other than the intra or inter-transform depth information.

For the inverse-transform decoding of the differential signal, the transform depth information defined for the inter-picture prediction, the transform depth information defined for the intra-picture prediction, and the third transform depth information may be defined in the sequence parameter sets (SPS).

Meanwhile, in step S630, when the target block of the second layer is determined as the prediction without the differential signal, that is, the intraBL_skip prediction block, the inverse-transform decoding and the inverse-quantizing may be omitted.

The present invention relates to encoding and decoding of the video including a plurality of layers or views, and the plurality of layers may be expressed by first, second, and third layers or views. As described above, the video having the first layer and the second layer is described as an example, but even when the bit stream includes three or more layers, the inter-layer prediction of the same method described above may be applied.

In the aforementioned embodiments, methods have been described based on flowcharts as a series of steps or blocks, but the methods are not limited to the order of the steps of the present invention and any step may occur in a step or an order different from or simultaneously as the aforementioned step or order. Further, it can be appreciated by those skilled in the art that steps shown in the flowcharts are not exclusive and other steps may be included or one or more steps do not influence the scope of the present invention and may be deleted. The aforementioned embodiments include examples of various aspects.

All available combinations for expressing various aspects cannot be described, but it can be recognized by those skilled in the art that other combinations can be used. Therefore, all other substitutions, modifications, and changes of the present invention that belong to the appended claims can be made.

What is claimed is:

1. A video decoding method supporting a plurality of layers, comprising:
decoding a first layer which is referred by a target block of a second layer to be decoded;
determining a size of the target block of the second layer which uses information on the first layer; and
performing prediction for the target block by using the information on the first layer according to a determined result.

2. The video decoding method of claim 1, wherein:
in the determining of the size of the target block,
all allowable block sizes defined in an encoding apparatus are determined as the size of the target block.

3. The video decoding method of claim 1, wherein:
in the determining of the size of the target block,
a block size set by a predetermined rule implicitly defined with the encoding apparatus is determined as the size of the target block.

4. The video decoding method of claim 1, wherein:
in the determining of the size of the target block,
a maximum block size allowed in the encoding apparatus is determined as the size of the target block.

5. The video decoding method of claim 1, wherein
in the determining of the size of the target block,
a minimum block size allowed in the encoding apparatus is determined as the size of the target block.

6. The video decoding method of claim 1, wherein:
the determining of the size of the target block includes parsing a size range indicator transmitted from the encoding apparatus,
the size range indicator includes any one of a maximum size range syntax element and a minimum size range syntax element transmitted and included in any one of SPS, PPS, and a slice header.

7. The video decoding method of claim 1, wherein:
the determining of the size of the target block includes parsing a maximum size range syntax element of the target block expressed by a difference value between the indicator for the minimum block size allowed in the encoding apparatus transmitted from the encoding apparatus and the minimum block size,
the maximum block size of the target block is determined by a sum of the minimum block size by the indicator and the difference value.

8. The video decoding method of claim 1, wherein:
in the determining of the size of the target block,
a syntax element expressed by the difference value between the minimum block size and the maximum block size allowed in the encoding apparatus transmitted from the encoding apparatus is parsed.

9. The video decoding method of claim 1, wherein:
the performing of the prediction for the target block includes
parsing flag information indicating using the first layer, when intraBL prediction is applied to the target block; and
using a decoded block signal of the first layer as a prediction signal with a differential signal, when the flag information is 1.

10. The video decoding method of claim 1, wherein:
the performing of the prediction for the target block includes
parsing flag information indicating using the first layer, when intraBL_skip prediction is applied to the target block; and
using a decoded block signal of the first layer as a prediction signal without a differential signal, when the flag information is 1.

11. A video decoding apparatus supporting a plurality of layers, comprising:
a first layer decoding module configured to decode a first layer which is referred by a target block of a second layer to be decoded; and
a second layer decoding module configured to determine a size of the target block of the second layer which uses the information of the first layer and perform prediction for the target block by using the information of the first layer according to the determined result.

12. The video decoding apparatus of claim 11, wherein
the second layer decoding module determines all allowable block sizes defined in an encoding apparatus as the size of the target block.

13. The video decoding apparatus of claim 11, wherein:
the second layer decoding module determines a block size set by a predetermined rule implicitly defined with the encoding apparatus as the size of the target block.

14. The video decoding apparatus of claim 11, wherein:
the second layer decoding module determines a maximum block size allowed in the encoding apparatus as the size of the target block.

15. The video decoding apparatus of claim 11, wherein:
the second layer decoding module determines a minimum block size allowed in the encoding apparatus as the size of the target block.

16. The video decoding apparatus of claim 11, wherein:
the second layer decoding module parses a size range indicator transmitted from the encoding apparatus, and
the size range indicator includes any one of a maximum size range syntax element and a minimum size range syntax element transmitted and included in any one of SPS, PPS, and a slice header.

17. The video decoding apparatus of claim 11, wherein:
the second layer decoding module parses a maximum size range syntax element of the target block expressed by a difference value between the indicator for the minimum block size allowed in the encoding apparatus transmitted from the encoding apparatus and the minimum block size, and
the maximum block size of the target block is determined by a sum of the minimum block size by the indicator and the difference value.

18. The video decoding apparatus of claim 11, wherein:
the second layer decoding module parses a syntax element expressed by the difference value between the minimum block size and the maximum block size allowed in the encoding apparatus transmitted from the encoding apparatus.

19. The video decoding apparatus of claim 11, wherein:
the second layer decoding module parses flag information indicating using the first layer, when intraBL prediction is applied to the target block, and uses a decoded block signal of the first layer as a prediction signal with a differential signal, when the flag information is 1.

20. The video decoding apparatus of claim 11, wherein:
the second layer decoding module parses flag information indicating using the first layer, when intraBL_skip prediction is applied to the target block, and uses a decoded block signal of the first layer as a prediction signal without a differential signal, when the flag information is 1.
